(19) United States
(12) Patent Application Publication
(10) Pub. No.: US 2005/0129866 A1
(43) Pub. Date: Jun. 16, 2005

(54) Coating process of aluminium oxide on the surface of plastic floor tiles

(76) Inventor: Ko Chun-Shien, Tah Sheh Hsiang (TW)

Correspondence Address: TROXELL LAW OFFICE PLLC;SUITE 1404, 5205 LEESBURG PIKE, FALLS CHURCH, VA, 22041, US

(21) Appl. No.: 10/735,652

(22) Filed: Dec. 16, 2003

(51) Int. Cl. B05D 1/02; B29C 71/02

(52) U.S. Cl. 427/427.1; 427/402; 427/532

(57) ABSTRACT

A coating process of aluminum oxide on the surface of a plastic floor tile includes plural steps consisting of a step of placing a half-finished plastic floor tile on a feeding table, two steps of coating two layers of UV photo-curing resin and a step of spraying a layer of aluminum oxide sand sandwiched between the two layers of UV photo-curing resin, and two steps of curing the two layers of UV photo-curing resin by light shining by one or more UV lamps, and a step of cooling the cured surface of a finished plastic floor tile and a last step of placing and storing a completely finished plastic floor tile on a receiving table.

### BACKGROUND OF THE INVENTION

1. Field of the Invention

This invention relates to a coating process of aluminum oxide on the surface of a plastic floor tile, particularly to one including two rounds of coating a layer of UV photo-curing resin on a surface of a half-finished plastic floor tile, and one round of spraying aluminum oxide sand positioned between the two layers of UV photo-curing resin to let the aluminum oxide sand not sink down but project up the surface of the first layer of UV photo-curing resin on a finished product. Then the plastic floor tile is characterized by the aluminum oxide layer sandwiched between the two layers of UV photo-curing resin, having enhanced properties of anti-abrasion, anti-scraping, anti-slipping and preventing the aluminum oxide sand from falling off, with the aluminum oxide sand evenly attached with the first layer of the UV photo-curing resin.

2. Description of the Prior Art

Traditional plastic floor tiles are easy to arrange and fixed, but not so good as traditional porcelain or stone floor tiles in the misty feeling, anti-abrasion, anti-scraping, anti-slipping, anti-corrosion, and pressure-enduring. And recently, some plastic tiles added with aluminum oxide have been used to improve the above-mentioned drawbacks.

FIG. 1 shows a block chart of coating process of a conventional plastic floor tile. A layer of UV photo-curing resin (111A) is coated on the surface of a half-finished plastic floor tile (10A) and the not-yet-cured layer is shone and photo-cured by a UV lamp to become a finished plastic floor tile (1A).

FIG. 2 shows a flowing chart of a coating process of the conventional plastic floor tile, and FIG. 3 shows a cross-sectional view of a finished conventional plastic floor tile. The layer of UV photo-curing resin (111A) is added with a metal oxide with anti-scraping and anti-abrasion property, and aluminium oxide is an excellent additive with extremely good anti-abrasion and anti-scraping. Therefore, aluminum oxide (110A) is added in the layer of UV photo-curing resin (111A) formed by means of roller coating (100A) on a half-finished plastic floor tile (10A). Nevertheless, during coating process, aluminum oxide (110A) is rather heavy and quick to sink down, so it may sink in the UV photo-curing resin (111A) and remain quite thin in the layer of UV photo-curing resin formed by the roller (101A). Thus the surface of the conventional finished plastic floor tile (1A) has an inferior misty and sandy surface because of the aluminum oxide impossible to project up the surface of the layer of UV photo-curing resin (111A). Subsequently, the surface of the conventional plastic floor tile cannot have the property of good anti-abrasion, anti-scraping, or the same texture as the superficial misty feeling of floor tiles made of porcelain or stone. In order to achieve the effect of not sinking down for aluminum oxide in the layer of UV photo-curing resin, the volume percentage of aluminum oxide (110A) in UV photo-curing resin (111A) has to be increased, but on the other hand, the viscosity of the UV photo-curing resin with the aluminum oxide is also augmented and so is its thickness to result in heightened cost, in spite of the anti-abrasion, anti-scraping property elevated.

Further, as shown in FIGS. 2, 4 and 5, silicon dioxide (SiO₂) (120A) instead of metal oxide is used to be added in UV photo-curing resin, as it is rater light and sinking slower than metal oxide. After UV photo-curing resin with silicon dioxide is coated on a half-finished plastic floor tile by a roller (101A), it is cured by means of a UV lamp to become a finished product having the same misty sandy feeling of its surface. Though silicon oxide is light, it is liable to be squeezed and unable to project up the surface of the UV photo-curing resin layer, having much less misty sandy feeling and less anti-abrasion, anti-scraping or anti-slipping property than those made of porcelain and stone.

In general, the conventional plastic floor tiles have the following drawbacks.
1. Aluminum oxide is liable to sink down in UV photo-curing resin because of its heavy specific gravity when mixed in the latter.
2. In coating process, such a misty sandy feeling of a surface got in porcelain or stone floor tiles cannot be obtained in conventional plastic floor tiles with coating a UV photo-curing resin layer by means of a roller.
3. The surface of the conventional plastic floor tile cannot have the good effect of anti-abrasion, anti-scraping or anti-slipping because of aluminum oxide already sunk in the UV photo-curing resin layer.
4. In coating process, although the conventional plastic floor tile may have anti-abrasion, anti-scraping and anti-slipping property by increasing the amount of aluminum oxide, the UV photo-curing resin plus aluminum oxide also augments its viscosity and the thickness of its layer as well, enhancing its cost accordingly.
5. In coating process, silicon dioxide mixed in the UV photo-curing resin layer is impossible to project up the surface of the UV resin layer, making up a bad misty sandy feeling of its surface of the conventional plastic floor tile, resulting in inferior anti-abrasion, anti-scraping or anti-slipping property.

### SUMMARY OF THE INVENTION

The purpose of the invention is to offer a coating process of aluminum oxide on a plastic floor tile provided with excellent properties of attaching, anti-abrasion, anti-scraping, anti-slipping, anti-corrosion, pressure-enduring, and a solid texture of its surface.

The coating process includes several steps for mainly coating two layers of UV photo-curing resin by means of a roller and a layer of aluminum oxide on the first layer of UV resin by means of spraying on a surface of a half-finished plastic floor tile in an even balanced and non-sinking condition, and curing the two layers of UV photo-curing resin by means of one or more UV lamps. Then it becomes a finished plastic floor tile, with the layer of aluminum oxide completely covered in the UV photo-curing resin layers and not falling off the plastic floor tile.

### BRIEF DESCRIPTION OF DRAWINGS

This invention will be better understood by referring to the accompanying drawings, wherein:

FIG. 1 is a block chart of a coating process of a conventional plastic floor tile;

FIG. 2 is a flowing chart of the coating process of a convention plastic floor tile;

FIG. 3 is a cross-sectional view of the conventional plastic floor tile coated with aluminum oxide by the process shown in FIGS. 1 and 2;

FIG. 4 is a cross-sectional view of the conventional plastic floor tile coated with silicon dioxide by the process shown in FIGS. 1 and 2;

FIG. 5 is a perspective view of the conventional plastic floor tile;

FIG. 6 is a block chart of a coating process of aluminum oxide on the surface of a plastic floor tile in the present invention;

FIG. 7 is a flowing chart of the coating process of aluminum oxide on the surface of a plastic floor tile in the present invention;

FIG. 7A is magnified views of the parts marked A, B and C in FIG. 7;

FIG. 8 is a cross-sectional view of a plastic floor tile made by the coating process in the present invention; and,

FIG. 9 is a perspective view of a plastic floor tile made by the coating process in the present invention.

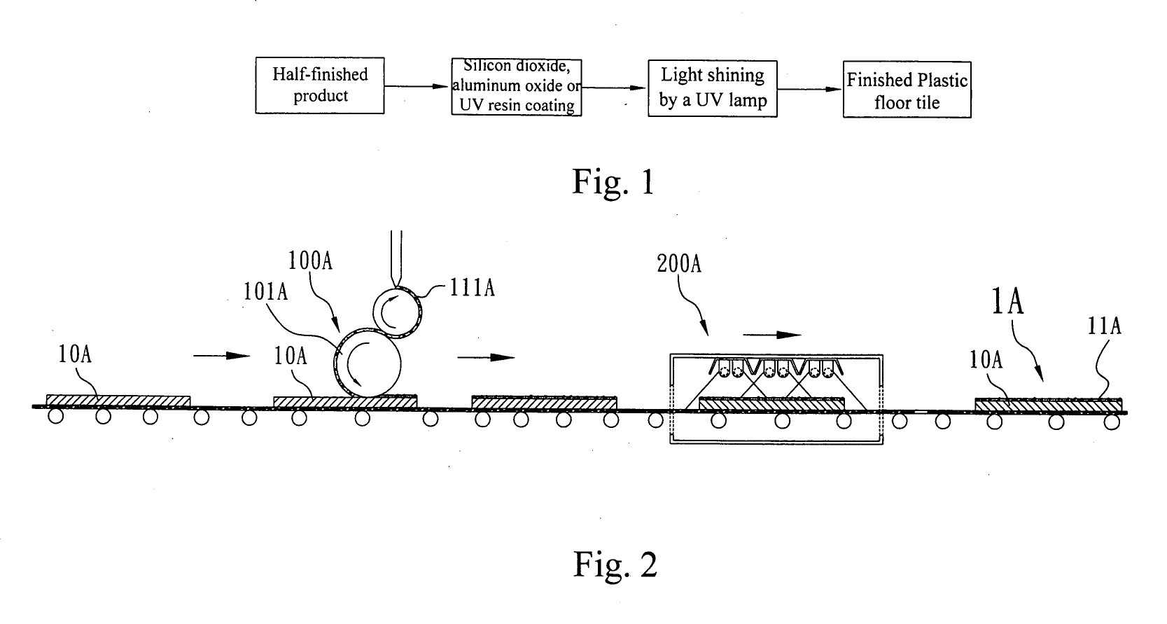

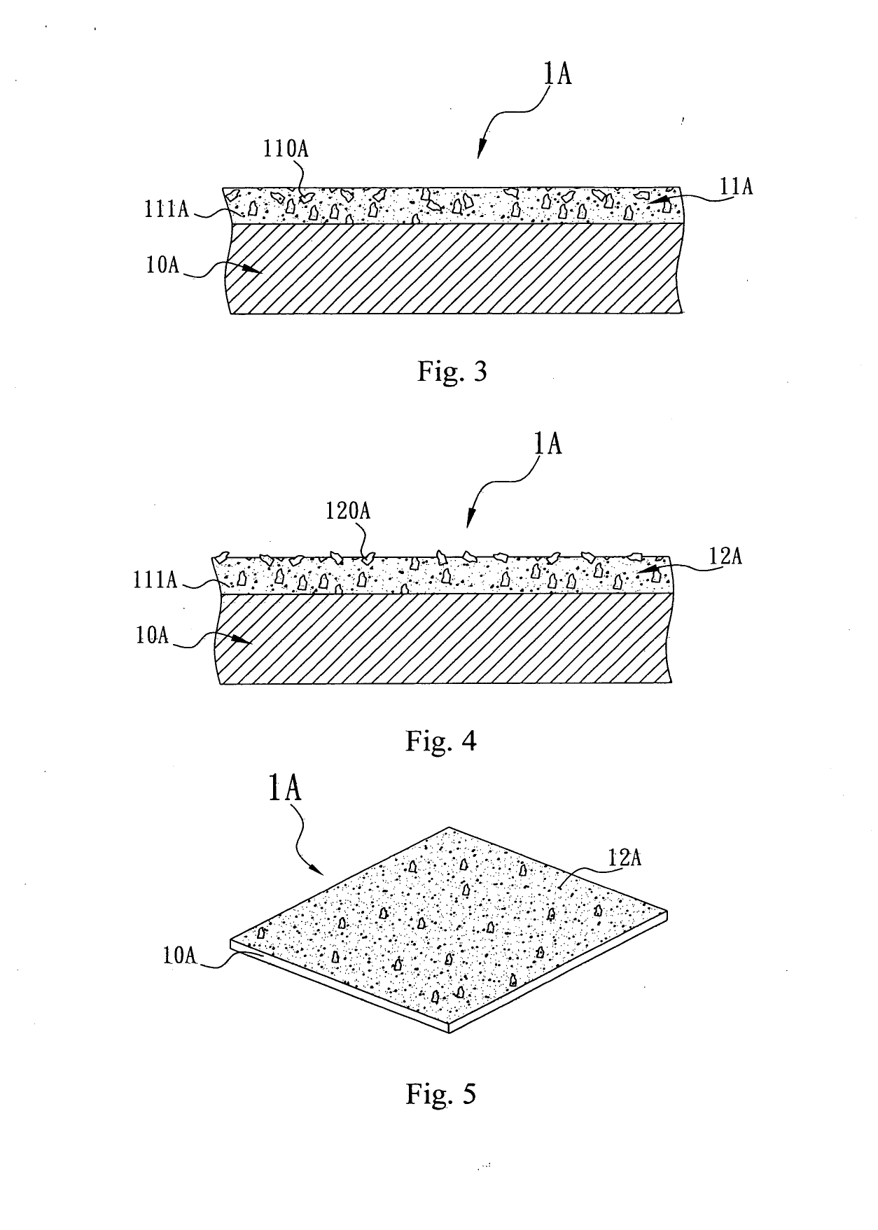

### DETAILED DESCRIPTION OF THE PREFERRED EMBODIMENT

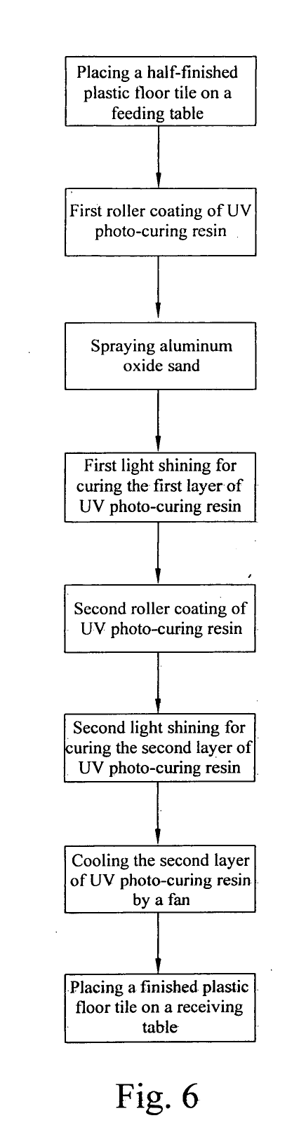

A preferred embodiment of a coating process of aluminum oxide on a plastic floor tile in the present invention, as shown as shown in FIGS. 6, 7, 7A, 8 and 9, includes eight steps. A first step is preparing and placing a half-finished plastic floor tile 10 on a feeding table. A second step is coating a first layer of UV photo-curing resin 11 on a surface of the half-finished plastic floor tile 10 by means of first roller coating 100. A third step is forming a layer of aluminum oxide sand 12 on the first not-yet-cured layer of the UV photo-curing resin 11 on the half-finished plastic floor tile 10 by means of spraying 200 by a sandblast machine 201. A fourth step is curing the first not-yet-cured layer of UV photo-curing resin by a first round of light shining 300 by means of one or more UV lamps. A fifth step is second coating 400 a second layer of UV photo-curing resin on the first cured layer of UV photo-curing resin 11 mixed with the aluminum oxide sand layer 12. A sixth step is curing the second not-yet-cured layer of UV photo-curing resin 11 by second light shining 400 by means of one or more UV lamps. A seventh step is heat-dispersing 600 of the almost finished plastic floor tile by means of a fan. A final eight step is placing and storing the completely finished plastic floor tile on a receiving table.

Now the detail of every step is to be described as follows. The first step is to place a half-finished plastic floor tile 10 on a feeding table for carrying out subsequent steps, and the second step is first coating 101 a first wet layer of UV photo-curing resin 11 on the surface of the half-finished plastic floor tile 10 by a roller. The third step is to spray (200) a layer of aluminum oxide sand 12 on the first not-yet-cured layer of UV photo-curing resin 11 in an even and balanced condition by means of a sand blasting machine 201 to let the layer of aluminum oxide sand 12 completely attached on the layer of UV photo-curing resin 11 and let aluminum oxide sand project up the surface of the first cured layer of UV photo-curing resin 11 so that the surface of the finished plastic floor tile may have the same misty sandy surface as that of floor tiles made of porcelain and stone. And this kind of coating process does not produce plastic floor tiles with aluminum oxide sand 12 sinking down in the first layer of UV photo-curing resin 11 owing to the heavy specific gravity of aluminum oxide sand 12.

Further, the fourth step is a first round of light shining (300) by means of one or more UV lamps on the first not-yet-cured layer of UV photo-curing resin 11 attached with a layer of aluminum oxide sand 12 to let the first layer of UV photo-curing resin 11 to cure so that the aluminum oxide sand 12 may completely covered with the second layer of UV photo-curing resin, without possibility of falling off by external force. Then the fifth step is second roller coating (400) a second layer of UV photo-curing resin 11 on the first cured layer of UV photo-curing resin 11 with the layer of aluminum oxide sand 12 by roller coating 401. Then the second layer of UV photoOcuring resin 11 may be coated on the layer of aluminum oxide sand 12 in an even and balanced condition, with the aluminum oxide sand layer completely covered by the second layer of UV photo-curing resin 11. The sixth step is second light shining (500) by means of one or more UV lamps on the second not-yet-cured layer 13 of UV photo-curing resin to let the second not-yet-cured layer 13 to cure, with the layer of aluminum oxide sand 12 totally covered by the second layer 13 of UV photo-curing resin. Then the layer of aluminum oxide sand is hardly possible to fall off, with the aluminum oxide sand layer 12 tantamount to be protected by an upper covering, having almost the same misty and sandy feeling of the surface of floor tiles made of porcelain and stone and provided with excellent properties of attaching, anti-abrasion, anti-scraping, anti-corrosion, pressure-enduring, and a protective layer of solid texture. The seventh step is to disperse the heat of the second cured layer of UV photo-curing resin, and the last eighth step is to send and placing the completely finished plastic floor tile onto a receiving table 700.

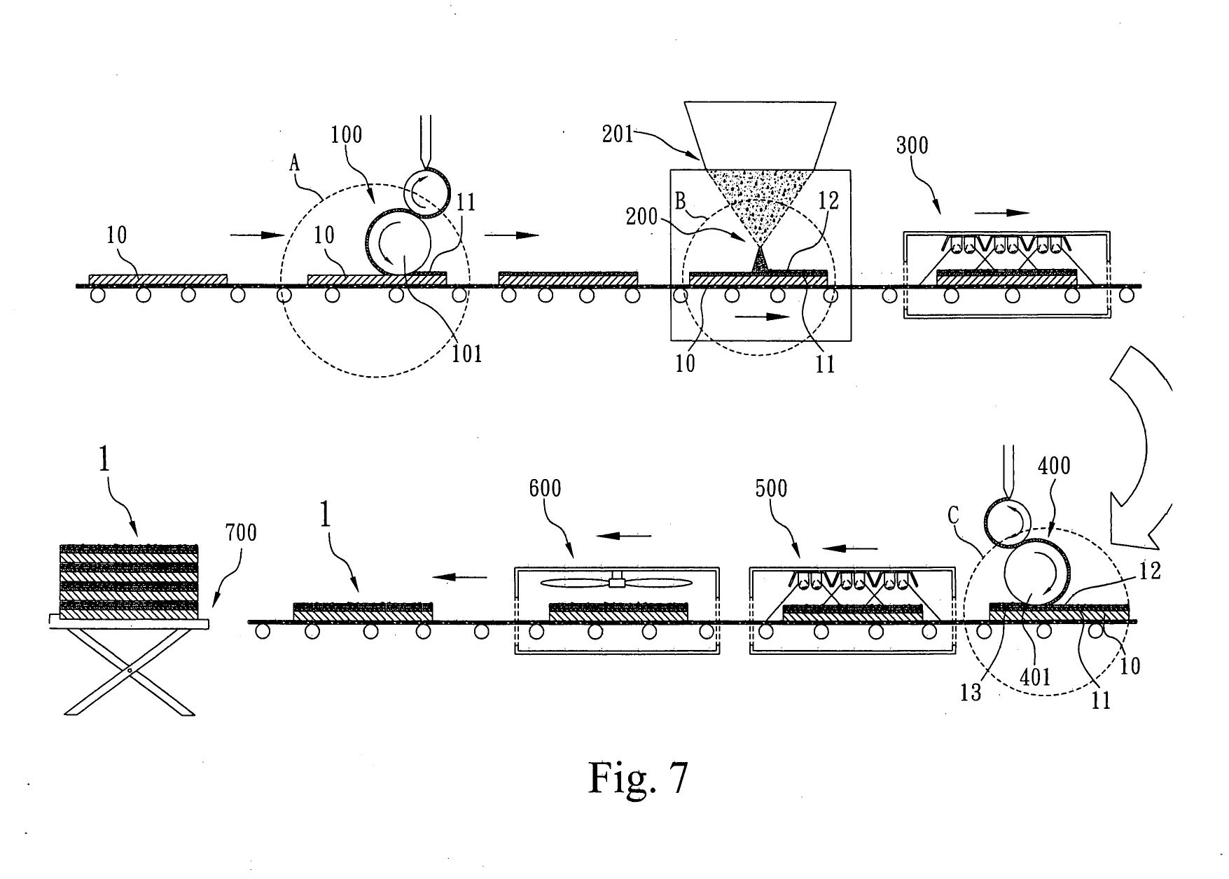

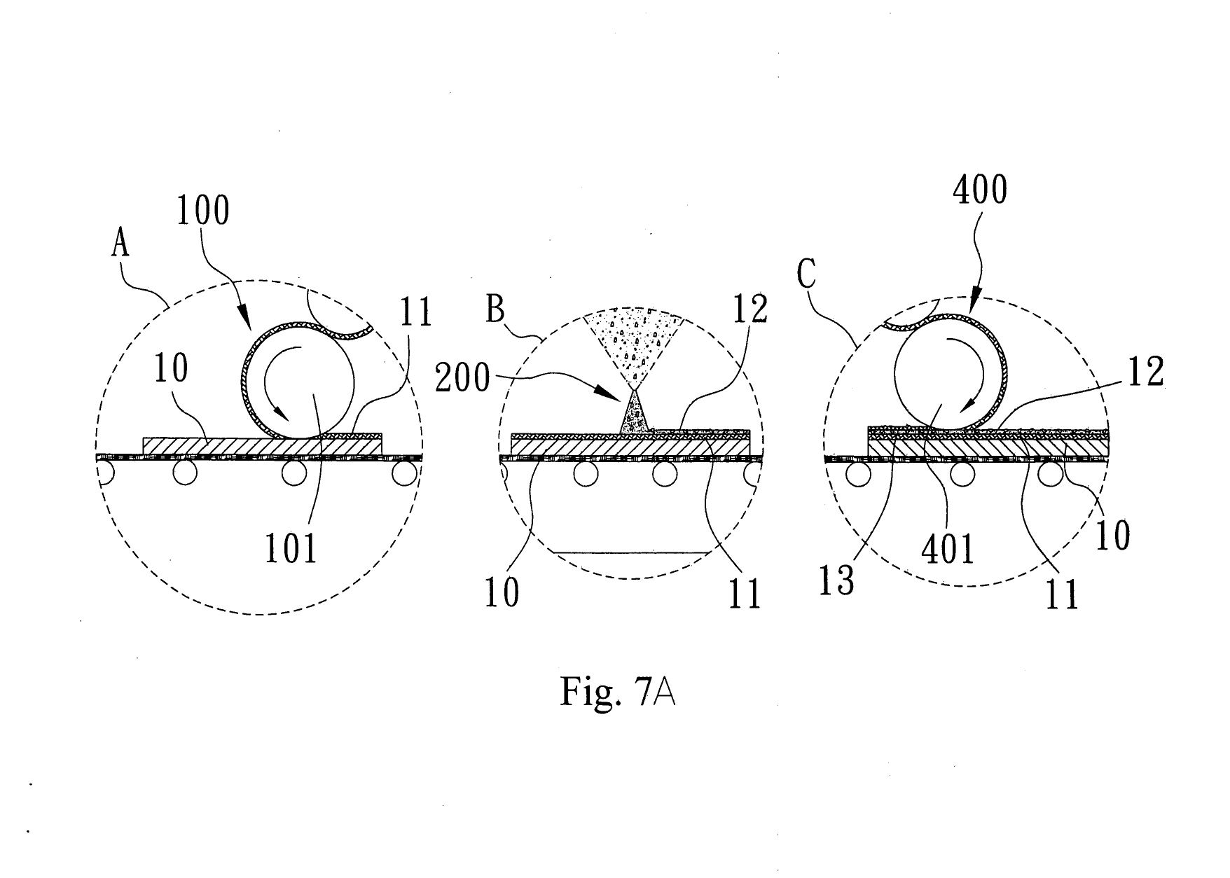

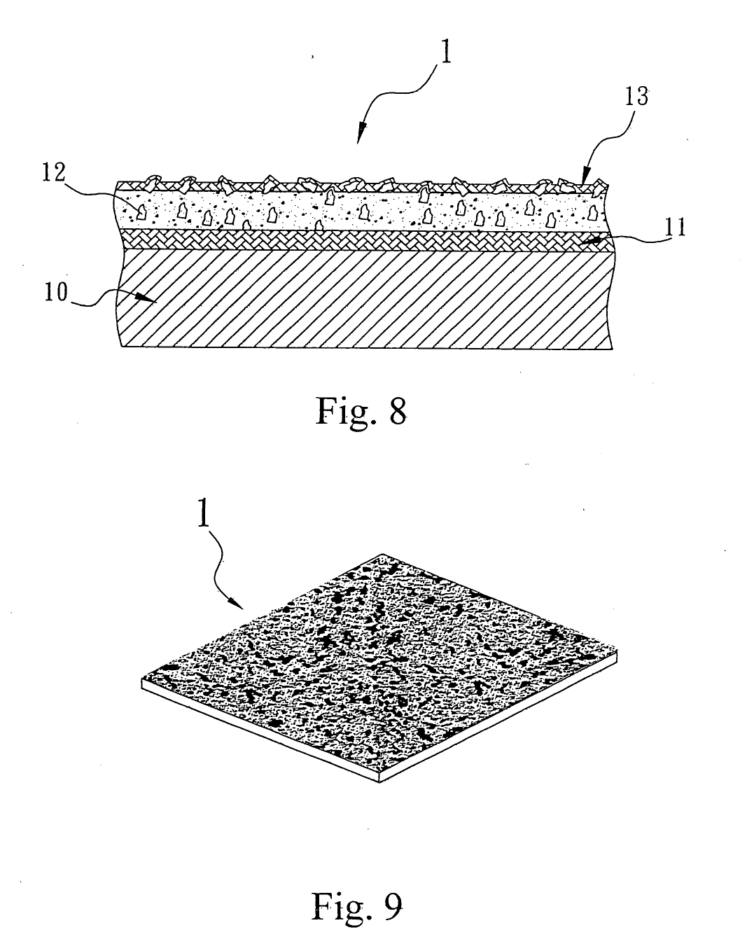

Next, FIGS. 7A and 8 show the coated condition (A) of the first roller coating (100) of UV photo-curing resin 11, and the sprayed condition (B) of the layer of aluminum oxide sand 12 on the first not-yet-cured layer of UV photo-curing resin 11, with the layer of aluminum oxide sand 12 totally attaching the first layer 11 of the UV photo-curing resin without possibility of falling off by exterior force. And the second roller coating condition (C) of the second layer 13 of UV photo-curing resin by the second roller coating (400) makes up a protective covering for the layer of aluminum oxide sand 12 to let it more difficult to fall off. Then the finished plastic floor tile may have functions of anti-slipping, anti-abrasion, anti-scraping and an appearance of solid texture.

The coating process of aluminum oxide on the surface of a plastic floor tile according to the invention has the following advantages, as can be understood from aforesaid description.
1. Aluminum oxide sand can be attached evenly on the first layer of UV photo-curing resin coated on a half-finished plastic floor tile by means of spraying.
2. Aluminum oxide does not sink down in the first layer of UV photo-curing resin by means of spraying.
3. The two layers of UV photo-curing resin can reinforce anti-abrasion and anti-scraping function of the surface of a finished plastic floor tile.
4. The two layers of UV photo-curing resin can prevent the layer of aluminum oxide sand sandwiched between them from falling off.
5. The two layers of UV photo curing resin plus the layer of aluminum oxide sand sandwiched between them can make up almost the same misty and sandy feeling for the surface of a finished plastic floor tile as the surface of a porcelain and a stone floor tile.
6. The surface of a finished plastic floor tile made according to the invention has a solid texture and an anti-slipping function

While the preferred embodiment of the invention has been described above, it will be recognized and understood that various modifications may be made therein and the appended claims are intended to cover all such modifications that may fall within the spirit and scope of the invention.

1. A coating process of aluminum oxide on the surface of a plastic floor tile comprising:
A. A first step of preparing and placing a half-finished plastic floor tile on a feeding table:
B. A second step of coating a first layer of UV photo-curing resin on a surface of the half-finished plastic floor tile by means of a set of spraying appliance;
C. A third step of forming a layer of aluminum oxide sand on the first not-yet-cured layer of UV photo-curing resin formed in the second step by means of a spray appliance;
D. A fourth step of curing the first not-yet-cured layer of UV photo-curing resin formed in the second step with the layer of aluminum oxide sand by light shining by means of one or more UV lamps:
E. A fifth step of forming a second layer of UV photo-curing resin on the cured layer of UV photo-curing resin finishing the fourth step by means of a coating appliance:
F. A sixth step of curing the second not-yet-cured layer of UV photo-curing resin coated in the fifth step by light shining by means of one or more UV lamps:
G. A seventh step of cooling the heat of the second cured layer of UV photo-curing resin finishing the sixth step by means of a heat dispersing device:
H. An eighth step of placing and storing the finished plastic floor tile finishing the seventh step onto a receiving table.

2. The coating process of aluminum oxide on the surface of a plastic floor tile as claimed in claim 1, wherein said coating appliance is a roller.

3. The coating process of aluminum oxide on the surface of a plastic floor tile as claimed in claim 1 wherein said coating appliance is one possible to coat paint on a plastic floor tile.

4. The coating process of aluminum oxide on the surface of a plastic floor tile as claimed in claim 1, wherein said spraying appliance is a sandblast machine.

5. The coating process of aluminum oxide on the surface of a plastic floor tile as claimed in claim 1, wherein said two layers of UV photo-curing resin with the layer of aluminum oxide said sandwiched between said two layers of UV photo-curing resin make the finished plastic floor tile provided with excellent property of anti-abrasion and anti-slipping.

6. The coating process of aluminum oxide on the surface of a plastic floor tile as claimed in claim 1, wherein said layer of aluminum oxide sand makes the finished plastic floor tile provided with excellent property of anti-abrasion and anti-slipping.

7. The coating process of aluminum oxide on the surface of a plastic floor tile as claimed in claim 1, wherein said heat dispersing device is a heat-dispersing
